(19) United States
(12) Patent Application Publication
(10) Pub. No.: US 2009/0197219 A1
(43) Pub. Date: Aug. 6, 2009

(54) SYSTEM FOR A DENTAL IMPLANT SURGICAL GUIDE

(76) Inventor: Rosario Rizzo, Roncadelle (IT)

Correspondence Address: MCGLEW & TUTTLE, PC, P.O. BOX 9227, SCARBOROUGH STATION, SCARBOROUGH, NY, 10510-9227, US

(21) Appl. No.: 12/375,330

(22) PCT Filed: Jul. 30, 2007
(86) PCT No.: PCT/IT07/00543

§ 371 Date: Jan. 27, 2009

(30) Foreign Application Priority Data
Aug. 2, 2006 (IT) BS 2006 A 000169

(51) Int. Cl. A61C 8/00

(52) U.S. Cl. 433/173; 433/215

(57) ABSTRACT

The invention concerns guided dental implant surgery involving the preparation of a model with balls indicatine the emergent point of each implant, the preparation of a radiological plate starting from the model and equipped with a radiopaque ball placed in the cast corresponding to each ball of said model, the application of a reference fork for the radiological claque for the carrying out of a CAT scan, the elaboration of the CAT scan data with reference to the emergent point of the implant and successive preparation of a surgical guide with fixing of a directional sleeve on the plaque starting from the emergent point.

This invention concerns the surgical field in general and in particular dentistry and especially a system for guided implant surgery.

In dental surgery, a missing tooth is often replaced by an artificial tooth that is mounted on a dental implant, inserted beforehand in the patient's mandibular or jaw bone. The dental implant must be inserted in the bony tissue so that it is as stable as the root of a normal tooth and accurately positioned.

The procedures used to install a dental implant include in particular the carrying out of osteotomy, that is the drilling of a hole in the jaw or mandibular bone, the insertion of the dental implant in the hole followed by fixing of the artificial tooth to the implant. The dental implant is usually made of titanium or a titanium alloy and must be able to rapidly integrate with the bone of the patient. However, the positioning of the osteotomic drilling operation carried out beforehand must be accurate, maintain the distance from the adjacent teeth and be at a correct angle so as not to cause damage to any of the contiguous structures and to ensure the implant fits correctly and is acceptable from an aesthetical point of view.

Various types of technical proposals have already been put forward in the attempt to facilitate the positioning and formation of the drilling operation of the bone such as those described for example in U.S. Pat. No. 5,015,183, WO 2005/055 852, etc., plus systems using pre-set guide sleeve which however, in CAT sections appear to be deformed, in their different shapes, never in reality, all methods which, however, were found to be improvable.

In fact the aim of this invention is to create the conditions for guided implant surgery and which enables precise and safe positioning of maxillary dental implants.

The invention will however be illustrated in detail in the course of the description made in reference to the enclosed images, in which:

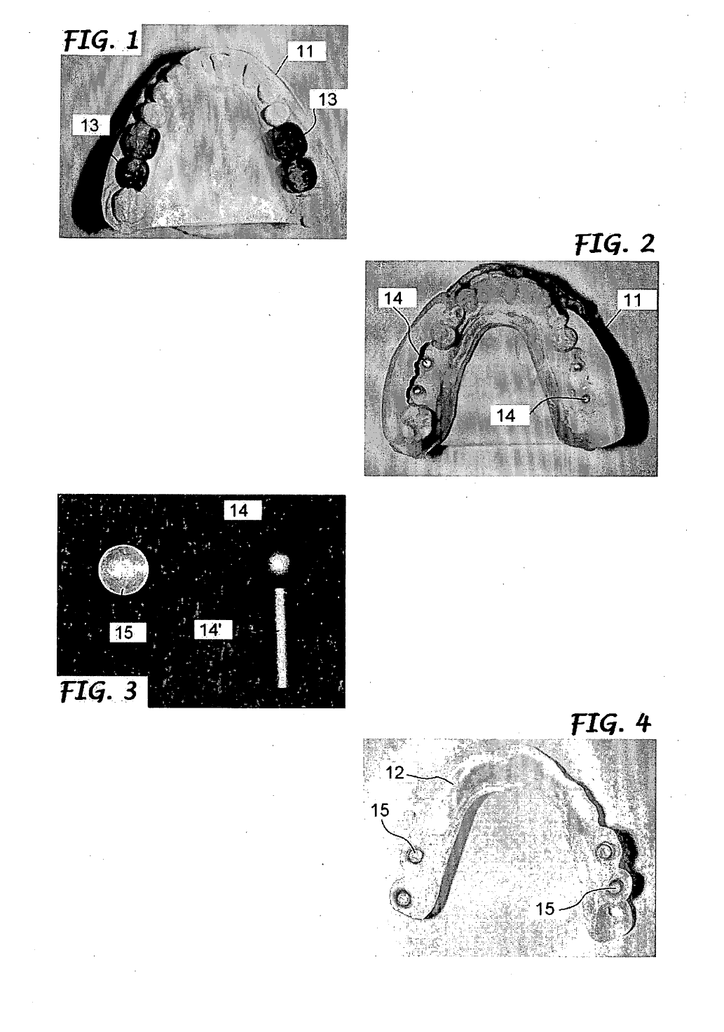

FIG. 1 shows a model obtained from a cast of a patient's mouth on which a dental prosthesis has been simulated;

FIG. 2 is the model of FIG. 1 with spherules instead of dental implants,

FIG. 3 an example of a ball with shaft and a crystal ball to be used according to the invention;

FIG. 4 shows a radiology guide sleeve.

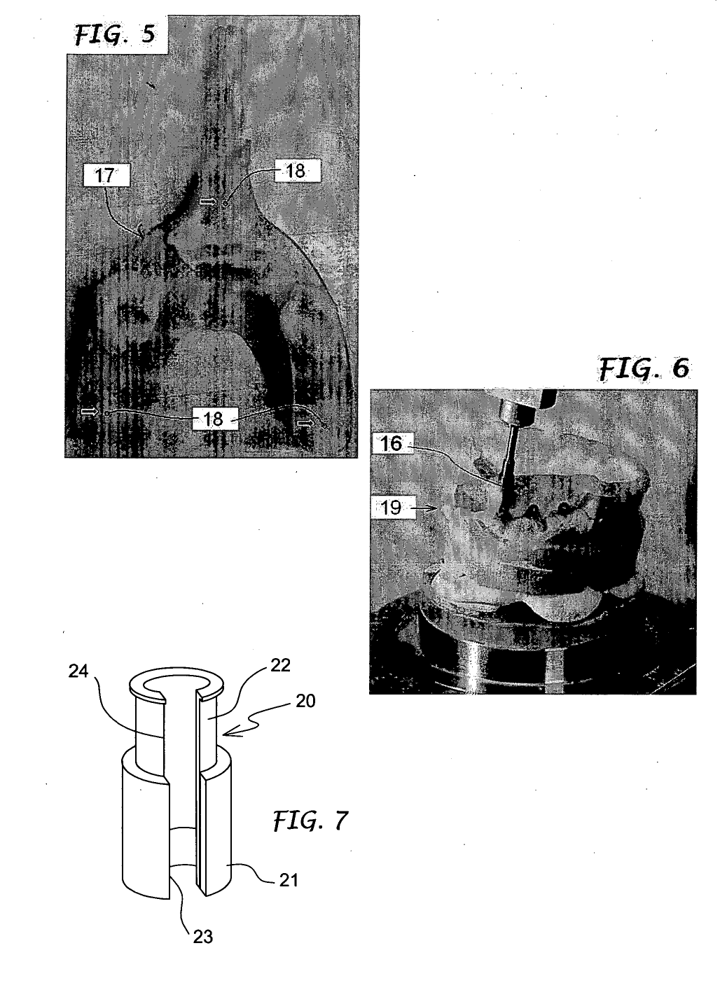

FIG. 5 shows a reference fork for carrying out a CAT scan.

FIG. 6 shows the construction of a surgical guide, and

FIG. 7 shows a telescopic tube for lateral insertion and the longitudinal guide of a burr or the like.

According to the invention, the positioning criteria of the implant and consequently the characteristics of the hole to be drilled in the bone (entry position, direction, depth etc.) are established, during the project phase, according to the type of prosthesis chosen.

The resin product (template) all the different stages will be carried out on is made using a plaster cast 11 (FIG. 1), made from a mould of the patient's mouth, where the state of the art envisages on the other hand the realisation of a surgical sleeve, a prototype using stereolithography (STL) or the like, of untrustworthy precision.

The system of the invention involves the use of three different devices.
a radiological guide,
a specific monitor programme,
a device to achieve the final surgical guide, starting from the original radiological guide.

The radiological guide consists of a plaque 12 made, for example of resin, based on the plaster cast 11 of a mould of the patient's mouth on which the restorative dentistry using pre-shaped teeth 13 is simulated beforehand. This restorative dentistry consists in a diagnostic waxing as similar as possible to the one that will be the final finished implant with the possibility also of modelling the soft tissue.

After marking the necessary points and profiles on the model, the waxing is removed and, depending on the type of restorative dentistry to be carried out, the emergent point of the implant to be carried out is established. This emergent point (FIG. 2) is marked by a ball 14 made of metal or some other material, which has a shaft 14′ (FIG. 3) to fix it to the model 11. The ball 14 must have a preset and known diameter (e.g. 3 mm) corresponding to that of the crystal ball 15 (FIG. 3), which will be used later for the radiological guide, and that of a smaller directional sleeve 16, that will have to be the last to be positioned in the surgical guide. At this point the waxing process to produce the guide is carried out.

The guide-plaque 12 therefore reproduces exactly the cast of the metal spherules and the external side of the prosthesis, and a crystal ball 15 (corresponding to each metal ball 14 with shaft on the plaster model) is inserted into each cast and fixed to it using sealing wax.

Each crystal ball 15 will therefore form an exact point of reference for the easily identified implant emergent points, and which do not deflect the rays during a CAT scan. Furthermore, the ball 15 is not binding for the direction of the implant, as its geometry is identical whatever the angle of the X-rays passing through it and the read out is always precise.

A so-called fork 17 (FIG. 5) is integrated with the guide plaque in an occlusal position, said fork being made up of a flat U-shaped element holding crystal spherules 18 (e.g. 1.5 mm each) positioned according to the vertexes of a triangle and at a set distance one from the other. These spherules 18 enable a certain reference plane to be established corresponding to the position of the head of the patient during a CAT scan carried out successively.

The management programme has been devised to elaborate the results of a CAT scan made up of horizontal sections only in Dental Scan for dentistry purposes on a computer and for planning the position of each implant according to the space individuation criteria, taking into consideration:

the origin of the implant, to be characterized in its emergent point represented by corresponding ball 15 in the guide plaque 12,

dimension of the implant, understood to be its length, diameter, shape, etc.,

direction of the implant starting from the emergent point represented by the respective ball 15 and expressed in TILT and TURN angle settings that enables the transfer of the position from virtual to real.

individuation of the original reference plan of the axial of the CAT scan, for the virtual positioning of the patient in the implementation conditions of the radiography, through the abovementioned fork.

Furthermore the programme enables the point of origin (represented by the ball 15) of the implant to vary and the calculation of all the successive variations.

For the construction of a surgical guide 19 (FIG. 6), all the data elaborated and supplied by the management programme is then transferred to a device to produce a surgical guide complete with every directional sleeve 16 starting from the radiological guide.

This device, already described moreover, both as regards to its configuration and functioning in a previous patent IT 1 316 881, comprises three goniometers and a slide for micrometric movements according to two orthogonal x and y axes, plus a third vertical z axis. It therefore enables:
positioning of the radiology guide 12 according to the original investigation plan by the CAT, by evaluating the position of the spherules 18 of the fork 17; the radiology guide 12 according to the original CAT investigation, evaluating the position of the spherules 18 of the fork 17;
positioning and orientating angularly each directional tube 16 according to the TILT and TURN starting from the emergent point represented by the crystal ball 15 on the radiological guide 12, and on request,
moving the point of origin of the implant but maintaining the angular orientations.

To facilitate the operations to be carried out using a burr or the like in the mouth of the patient during dental implant surgery, the invention also proposes an innovative variable length guide tube 20 so as to be able to gain vertical space when it is used to guide a tool. As shown in FIG. 7, the guide tube 20 comprises a female tubular element 21 with a longitudinal lateral opening 22, and a male tubular element 23 also with a longitudinal lateral opening 24. The male element 23 is inserted into the female element 21, where it can slide telescopically so as to be able to change the length of the guide tube 20 according to requirements. When the lateral openings of the two elements are then aligned, they form a passage for the lateral introduction of the tool to be guided, whatever the length (or height) of the guide tube.

1. A system for guided dental implant surgery involving the following stages:
making a mold of the patient's mouth;
simulating a dental implant on said mold;
removing the dental implant from the mold and placing a ball in the part to indicate the emergent point of each tooth implant to be carried out;
making a radiological plaque guide on the mold preset in this way to reproduce the impression of each ball indicating the emergent point and then fixing a ball which is radiopaque but that does not deflect the rays, in said impression;
attaching a fork with at least three prongs to said radiological plaque guide, positioned according to the apexes of a triangle and at a set distance, to detected during a CAT scan, a certain reference plane and its correlation with the original axial plane of the CAT, and consequently the position of the patient's head;
elaborating the data of the CAT according to a preset program with particular reference to the emergent point, that is, at the origin of each implant represented by the ball on the guide plaque, according to the dimensions and the perspective (TILT and TURN) of the implant, the reference plane set by said fork for a virtual positioning of the patient on a device preset for the formation of a surgical guide; and
realization of a surgical guide by positioning the radiological guide according to the reference plane established by the CAT scan and said fork, the angular position of a directional sleeve according to the perspectives (TILT and TURN) detected by the CAT scan starting from the ball indicating the emergent point.

2. A system according to claim 1, further comprising besides the removal of each ball from the radiological plaque, repositioning of the radiological plaque on the initial mold and the fixing of the directional sleeve on the plaque starting from the emergent point indicated by the original ball on the mold.

3. A system according to claim 1, wherein the balls on the model are metal or plastic and the balls on the plaque are crystal.

4. A system according to claim 1, wherein the radiological guide plate is flattened and the fork is integral with said plate in a concealed position.

5. A system according to claim 1, further comprising a guide tube for tools to be used in dental implant surgery, wherein said guide tube has a telescopic configuration and a longitudinal lateral opening for lateral insertion of a tool.

6. A system according to claim 5, wherein the guide tube includes a female element with a longitudinal lateral opening and a male element inserted and sliding in the female element and comprising a longitudinal lateral opening which can be positioned in line with the longitudinal opening of said female element.

7. A system according to claim 2, wherein the radiological guide plate is flattened and the fork is integral with said plate in a concealed position.
